(19) United States
(12) Patent Application Publication
(10) Pub. No.: US 2015/0186885 A1
(43) Pub. Date: Jul. 2, 2015

(54) METHOD AND A SYSTEM FOR FACILITATING CREDIT BASED TRANSACTIONS

(71) Applicants: INNOVITI EMBEDDED SOLUTIONS PVT. LTD., Bangalore, Karnataka (IN); THE MOBILESTORE LIMTED, Mumbai, Maharashtra (IN)

(72) Inventors: Rajeev Agrawal, Bangalore (IN); Prem Kumar Gupta, Bangalore (IN); Amrita Tyagi, Bangalore (IN); Himanshu Chakrawarti, Mumbai (IN); Vijay Rajput, Mumbai (IN)

(21) Appl. No.: 14/415,203

(22) PCT Filed: Jul. 16, 2013
(86) PCT No.: PCT/IB13/55846

§ 371 Date: Jan. 16, 2015

(30) Foreign Application Priority Data
Jul. 17, 2012 (IN) 2895/CHE/2012
Jun. 13, 2013 (IN) 2582/CHE/2013

(51) Int. Cl. G06Q 20/40; G06Q 20/24

(52) U.S. Cl. CPC G06Q 20/403; G06Q 20/24

(57) ABSTRACT

Embodiment discloses a method comprising receiving, by a processor configured in a transaction server, transaction request from an acquiring server associated to an acquiring account. The transaction request comprises transaction related information including transaction amount, and is linked to at least one of an account and a credit balance account linked to credit limit. The transaction request is authorized, by an authorization module configured in processor, when the transaction amount is less than or equal to at least one of sum of balance in the account and credit limit in the credit balance account and the credit limit in the credit balance account. One or more tenure parameters along with authentication information are received by the processor upon authorizing transaction request. The one or more tenure parameters along with authentication information are transmitted to at least one of an issuing server and the credit balance account server by processor, wherein credit balance account server validates authentication information. Then, transaction amount is transferred to acquiring account upon validating authentication information for facilitating credit based transactions.

### CROSS-REFERENCE TO RELATED APPLICATIONS

This application is a 371 U.S. National Stage of International Application No. PCT/IB2013/055846, filed on Jul. 16, 2013, and published in English as WO 2014/013434 A2. This PCT application claims the priority benefit of Indian Patent Application Nos. 2895/CHE/2012, filed on Jul. 17, 2012 & 2582/CHE/2013, filed on Jun. 13 2013. The entire disclosures of the above applications are incorporated herein by reference.

### TECHNICAL FIELD

The present disclosure is related to electronic transactions. More particularly, the present disclosure is related to credit based transactions facilitating a user to use a credit balance to perform transactions.

### BACKGROUND

Presently, a customer can use a debit card, a credit card or a virtual credit card towards settling a purchasing amount at a merchant store. In case of using the debit card, the customer proposes a purchase and submits the debit card to the merchant so that the merchant can request authorization from a bank associated with the debit card. That is, the merchant checks that funds are available in a savings account associated with the debit card to cover the purchasing amount. This authorization process also provides an opportunity for security services, such as, verifying of a Personal Identification Number (PIN). If there are insufficient funds in the savings account associated with the debit card to cover the purchasing amount, then the authorization request is denied by the issuing bank, and the proposed purchase is rejected by the merchant. Many rejected consumers quickly give up and leave the merchant's premises when the proposed purchase is abandoned. Alternatively, the customer can use the credit card that allows the customer to avail credits towards paying for purchases at the time of purchase.

In case of using the credit card towards the purchase of goods on EMI basis, the customer must pay the purchase amount along with an interest rate to the issuer of a credit card within a predetermined period of time. The customer can pay the purchase amount and the interest rate with a single full payment or several smaller inequity payments or in Equity Monthly Installments (EMI) made over a period of time. Many customers prefer paying several smaller payments, instead of a single, larger payment. In return for allowing the customer to pay over a period of time, the issuer imposes interest on the balance. However, not all customers are eligible for credit cards and in case the customer avails credit beyond the free credit period, the rate of interest is typically high.

Conventionally, credits can be availed using a personal loan as well. The customer takes a personal loan from a bank or financing company and then pays back the same in installments. However, availing the personal loan is not instant and therefore cannot be availed at the time of buying a product or at the time of purchase. Availing the loan is cumbersome and may not be approved for every customer. Certain finance companies do offer credit instantly at the point of purchase; however it is available only for certain product categories that cost more than the cost available with the customer at the time of purchase. This limits the customer's ability to avail credit for any category of product.

Further, conventionally, installment-type payment plans are provided by the merchants, which suffer from several drawbacks. For example, a merchant must be assured that a customer is financially reliable. Therefore, the customer typically must obtain and complete a credit application, undergo a credit check and await credit approval, which is annoying and inconvenient to the customer. Also, the merchant is likewise inconvenienced by establishing such installment plans, processing credit applications, policing nonpayment of installments and incurring various other expenses. It is inconvenient, includes cumbersome manual process, and economically unfeasible to bill each month for small amounts. Additionally, merchants allow installment payments only for a limited selection of high-priced items, rather than for each item.

Hence, there is a need to provide a method and a system for facilitating credit based transactions for a user to use a credit limit to perform transactions in an easy and effective manner.

### SUMMARY:

The shortcomings of the prior art are overcome through the provision of a method and a system as described in the description.

The present disclosure is related to a method for facilitating credit based transactions. The method comprises receiving, by a processor configured in a transaction server connected to a network, a transaction request from an acquiring server associated to an acquiring account. The transaction request is linked to a credit balance account and comprises transaction related information including transaction amount. Next, the transaction request is authorized, by an authorization module configured in the processor, when the credit balance account is linked to credit limit and the transaction amount is less than or equal to the credit limit in the credit balance account. Later, one or more tenure parameters along with authentication information upon authorizing the transaction request is received by the processor from the acquiring server connected to the network. The one or more tenure parameters along with the authentication information is transmitted to a credit balance account server associated to the credit balance account by the processor, wherein the credit balance account server connected to the network validates the authentication information received by the processor. Then, the transaction amount is transferred to the acquiring account upon validating the authentication information by the credit balance account server for facilitating credit based transactions.

The present disclosure is related to a system for facilitating credit based transactions. The system comprises a computing device, a credit balance account server, an acquiring server and a transaction server. The acquiring server is configured to communicate over a network and is associated to an acquiring account. The credit balance account server is connected to the network and is associated to the credit balance account.

The computing device is connected over the network and comprises an input unit and a display unit. The computing device is used by a user to initiate the transaction request which is received by the acquiring server. The transaction server comprises a processor which is configured to receive a transaction request from the acquiring server associated to the acquiring account. The transaction request is linked to the credit balance account and comprises transaction related information including transaction amount. An authorization module configured in the processor authorizes the received transaction request when the credit balance account is linked to credit limit and the transaction amount is less than or equal to the credit limit in the credit balance account. One or more tenure parameters along with authentication information are received by the processor upon authorizing the transaction request. The processor transmits the one or more tenure parameters along with the authentication information to the credit balance account server associated to the credit balance account. The credit balance account server validates the authentication information received by the processor. The transaction amount is transferred to the acquiring account upon validating the authentication information by the credit balance account server for facilitating credit based transactions by the processor.

The present disclosure is related to a method for facilitating credit based transactions. The method comprises receiving, by a processor configured in a transaction server connected to a network, a transaction request from an acquiring server associated to an acquiring account. The transaction request is linked to a credit balance account and comprises transaction related information including transaction amount. Then, the transaction request is transmitted to a credit balance account server for authorization by the processor. The authorisation includes determining whether the credit balance account is linked to credit limit and the transaction amount is less than or equal to the credit limit in the credit balance account. After transmitting, one or more tenure parameters along with authentication information are received by the processor from the acquiring server upon authorizing the transaction request. Then, the received one or more tenure parameters along with the authentication information is transmitted to the credit balance account server associated to the credit balance account, wherein the authentication information is validated by the credit balance account server. The transaction amount is transferred to the acquiring account upon validating the authentication information by the credit balance account server for facilitating credit based transactions.

The present disclosure is related to a transaction server connected to a network comprises a processor is configured to receive a transaction request from an acquiring server associated to an acquiring account. The transaction request is linked to the credit balance account and comprises transaction related information including transaction amount. An authorization module configured in the processor authorizes the received transaction request when the credit balance account is linked to credit limit and the transaction amount is less than or equal to the credit limit in the credit balance account. One or more tenure parameters along with authentication information are received from the acquiring server upon authorizing the transaction request. The processor transmits the one or more tenure parameters along with the authentication information to a credit balance account server associated to the credit balance account, wherein the credit balance account server connected to the network validates the authentication information. The transaction amount is transferred to the acquiring account upon validating the authentication information by the credit balance account server for facilitating credit based transactions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS:

The features of the present disclosure are set forth with particularity in the appended claims. The disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates a system for facilitating a credit based transactions in accordance with an embodiment of the present disclosure;

FIG. 2 illustrates transaction server for facilitating a credit based transactions in accordance with an embodiment of the present disclosure;

FIGS. 3a illustrates an exemplary computing device installed with credit based transaction application in accordance with an embodiment of the present disclosure;

FIG. 3b shows entry of the one or more tenure parameters by a user on the exemplary computing device according to an embodiment of the present disclosure;

FIG. 4a illustrates another exemplary computing device used by a user to avail credit based transaction in an online shopping portal through a web browser in accordance with an embodiment of the present disclosure

FIG. 4b shows the entry of the one or more tenure parameters by a user on a payment gateway of an online shopping portal in accordance with an embodiment of the present disclosure; and

FIGS. 5 and 6 illustrates an exemplary method for facilitating a credit based transactions over network in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Embodiment of the present disclosure provides a credit based transactions to a purchaser/customer. The credit based transactions facilitates the customer with a credit amount on a debit card for settling a transaction amount at the time of purchase or availing services. In addition, embodiment of the present disclosure facilitates the customer to pay the credit amount in installments. For establishing the credit amount to the customer, the embodiment typically performs a check to determine “credit worthiness” i.e. whether the customer has at least one of balance in the debit card and the credit limit greater than the credit amount available in an associated account. When the at least one at least one of the balance in the debit card and the credit limit greater than the credit amount is available in the associated account, then the customer avails the credit amount towards settling the transaction amount by converting the credit amount into installments. The customer returns back the credit amount into the customer's credit account as per a tenure opted by the customer while converting the credit amount into installments. The tenure defines number of installments, installment amount and the predetermined time intervals for each installment within which the credit amount is returned back into the customer's associated account by the customer. Thus, the customer is benefitted with the credits at the time of purchase along with the option of installment plan and the seller or merchant also receives the full transaction amount at the time of purchase.

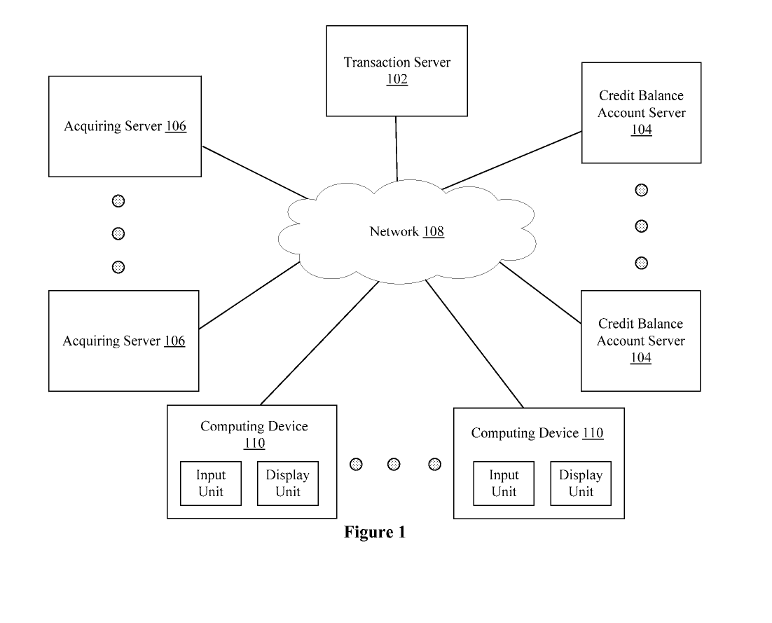

FIG. 1 illustrates a system for facilitating a credit based transactions in accordance with an embodiment of the present disclosure. The system comprises a network 108 connected to a transaction server 102, a plurality of credit balance account servers 104, a plurality of acquiring servers 106 and a plurality of computing devices 110. The network 108 includes, but is not limited to, a wide-area-network (WAN), General Packet Radio Service (GPRS), Enhanced Data Rates for Global Evolution (EDGE), Local Area Network (LAN), dial-up, Code Division Multiple Access (CDMA) and Wide Area network (WAN), e-commerce network, an information portal and a peer to peer (P2P) network. Therefore, there are no geographic limitations to the practice of the present invention. WAN may be referred to in this specification as Internet reflecting the preferred application of the present invention to online ecommerce shopping websites. The network 108 comprises many communication links. The communication links include, but is not limited to, hard wire links, optical links, satellite or other wireless communication links, wave propagation links, or any other mechanism for communication of information. Various communication protocols may be used to facilitate communication of information via the communication links, including Transmission Control Protocol (TCP)/Internet Protocol (IP), Hyper Text Transfer Protocol (HTTP), Hyper Text Transfer Protocol Secure (HTTPS), and Internet Protocol Security (IPsec) protocols, Extensible Mark-up Language (XML), Wireless Application Protocol (WAP), protocols under development by industry standards organizations, vendor-specific protocols, customized protocols, and others as known by those skilled in the art.

The transaction server 102 is communicatively connected to one or more credit balance account servers 104 and one or more acquiring servers 106 through the network 108. In an embodiment, the credit balance server 104 is a server associated to an issuing bank. The issuing bank maintains the accounts of the customer. The different types of accounts maintained by the issuing bank include but are not limited to, a savings account, a fixed deposit account and a checking account, a money market account. The issuing bank also maintains the credit balance accounts which include, but is not limited to, an overdraft (OD) account, a loan account, a mortgage account and installment loan account which are linked to the accounts. Therefore, the credit balance account server 104 comprises the accounts and the credit balance account. In an embodiment, the credit balance account is linked to a savings account. In an embodiment, the credit balance account is accessed through a debit card, virtual credit card or any suitable means encoding data which are issued by the issuing bank to the customer for facilitating a financial transaction to the customer. The debit card may be registered with the transaction server 102 regardless of the issuers or a branded network, associated to the credit balance account server 104. The debit card registration may be accomplished in a number of different ways including, but is not limited to for example, registration over the Internet or registration by paper application. In an embodiment, proprietary cards that are not branded may be registered with the transaction server 102.

Each of the credit balance account servers 104 and the acquiring servers 106 comprises a processing unit (not shown) and a storage unit (not shown). The processing unit of each of the credit balance account servers 104 maintain inflow and outflow of transaction amount towards the financial transactions to and from the accounts i.e. savings account of the customer. In an embodiment, the transaction server 102 assists in performing credit transactions towards the credit based financial transaction. The credit balance account and the savings account are maintained in the storage unit of credit balance account server 104.

The acquiring servers 106 are servers linked to the one or more computing devices 110 connected over the network like Internet. The computing device 110 includes, but is not limited to, point of sale (POS) device, Electronic Data Capture (EDC), Interactive Voice Response (IVR), Automated Teller Machine (ATM), mobile device, computer, Personal Digital Assistants (PDA), radio-related device, contactless device and communication devices capable of applying for credit against the credit balance account. For example, the customer logs into a shopping portal by browsing through the Internet using the computer or mobile device and initiates the transaction request, then the initiated transaction request is transmitted to the transaction server 102 for processing through the acquiring server 106 relating to the browsed shopping portal. In other case, for example, the merchant initiates a transaction request using the POS, and then the initiated transaction request flows to the transaction server 102 through the acquiring server relating to the POS. In an embodiment, the acquiring servers 106 are the servers of an acquiring bank and/or other financial institutions which are associated to an acquiring account. The acquiring account is an account related to including but not limited to, shopping websites or shopping portals and a merchant or seller or retailer at a retail shop, shopping mall, shopping complex and retail places, involved in offering for sale of goods or services to the customer. For example, “XXX” shopping portal has an acquiring account into which the transaction amount is transferred during the online credit based financial transaction. Likewise, the merchant at the retail shop has an acquiring account into which the transaction amount is transferred when the credit based financial transaction is initiated using the computing device 110 such as POS, EDC, ATM and IVR. The processing unit of each of the acquiring servers 106 maintain inflow of transaction amounts into the acquiring account from the savings account of the customer during the financial transactions.

The transaction server 102, the credit balance account servers 104 and the acquiring servers 106 are participating in a peer-to-peer networking environment. In an embodiment, the peer-to-peer networking environment includes receiving a transaction request from the acquiring server 106, transmitting the transaction request to the issuing bank and/or credit balance account server 104 for authorization, transmitting one or more tenure parameters to the issuing bank and/or credit balance account server 104 and transferring a transaction amount to the acquiring account associated to the acquiring server 106.

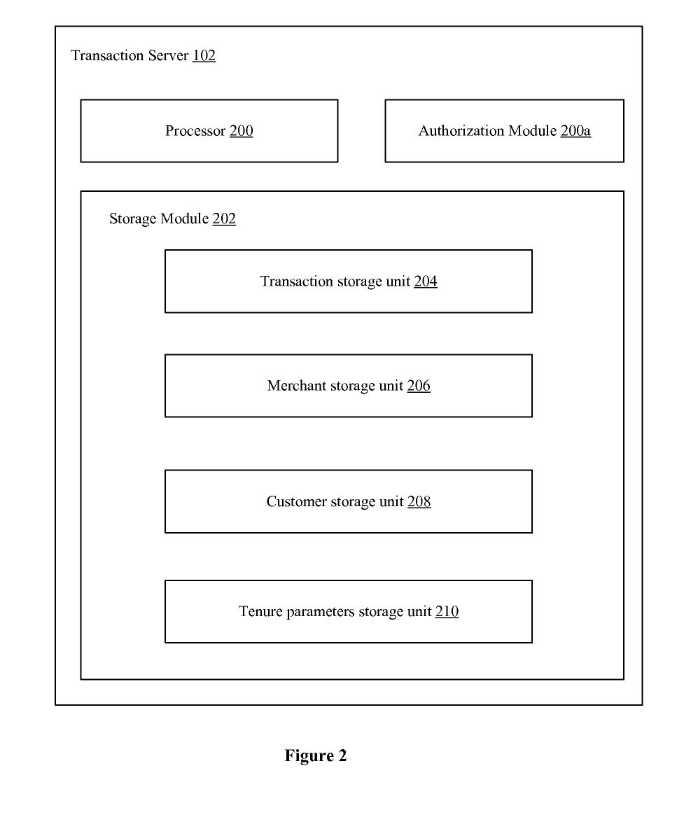

FIG. 2 illustrates an exemplary transaction server 102 for facilitating the credit based transactions in the network 108 in accordance with an embodiment of the present disclosure. The transaction server 102 comprises the processor 200, an authorization module 200a and a storage module 202. The processor 200 is configured to receive a transaction request from the acquiring server 106 associated to the acquiring account. The transaction request is initiated by the user i.e. merchant or seller using the computing device 110. The customer uses the debit card which is linked to a savings account. The transaction request includes, but is not limited to transaction related information, including transaction amount, debit card number, transaction code, transaction location, transaction identification (ID), transaction description, transaction originator, transaction date and transaction time. The transaction location is location at which the transaction request is initiated. In an exemplary embodiment, location of the shopping complex, retail market, retail shop and online portal information at which the transaction request is initiated. In an embodiment, the transaction location includes, but is not limited to, Internet Protocol (IP) address of the computing device 110 using which the user initiates the transaction request. The transaction code is a unique code associated to the transaction request. The transaction amount is the amount of purchase, for example, the customer purchasing a mobile phone of Rs.30000 is the amount of purchase. The transaction originator is the person who has initiated the transaction originally. The transaction originator can either be a merchant or a customer. The transaction date and the transaction time are the date and time respectively on and at which the transaction request is initiated. The transaction storage unit 204 configured in the storage module 202 stores the transaction informationThe transaction request is linked to the issuing bank and/or the credit balance account associated to the credit balance account server 104.

The transaction request is related between the merchant and the customer whose information are maintained by the storage module 202. A merchant storage unit 206 configured in the storage module 202 stores merchant related information including, but not limited to, merchant identification, merchant code, computing device 110 identification, computing device code and online portal information. A customer storage unit 208 configured in the storage module 202 for storing the customer related information including, but not limited to, customer authentication information, savings account details, credit balance account details, customer code and customer debit card details.

The authorization module 200a authorizes the transaction request when transaction amount is less than or equal to balance in the account associated to the issuing bank and credit limit in the credit balance account. For example, the customer/purchaser has a credit limit of Rs.5000 in his OD account and Rs.5000 in the savings account of the issuing bank. When the transaction request for purchasing a mobile phone of Rs.10000 is initiated and is received by the processor 200 from the acquiring server 106 which is linked to the computing device 110 using which the transaction request is initiated. Then, the authorization module 200a authorizes the transaction request by checking whether the purchaser's both the savings account and the credit balance account collectively has a credit limit (Rs.10000) greater than or equal to the transaction amount (Rs.10000). In another embodiment, the customer/purchaser has a credit limit of Rs.10000 in his OD account. The authorization module 200a authorizes the transaction request by checking whether the purchaser's the credit balance account has a credit limit (Rs.10000) greater than or equal to the transaction amount (Rs.10000).

After a successful authorization by the authorization module 200a, the processor 200 receives one or more tenure parameters along with authentication information of the customer from the acquiring server 106. The one or more tenure parameters along with authentication information are entered using the input unit of the computing device 110.

A tenure storage unit 210 configured in the storage module 202 stores one or more tenure parameters relating to installment based information or installment plans including, but not limited to, installment tenure, number of installments, installment amount, predefined intervals for installments, interest amount and interest rate. The installment tenure is the total period for which the installment is to be paid by the customer into the savings account at the issuing bank and/or the credit balance account server 104 associated to the issuing bank. The number of installments is the number of times the installment amount is to be paid by the customer to the customer's savings account managed by the issuing bank associated to the credit balance account server 104. The installment amount is the divided credit amount. The credit amount is the amount credited to the customer towards settling the transaction amount at the time of purchase or availing services.

In an embodiment, partial payment from the account associated to the issuing bank and the partial payment from the credit balance account in a single transaction towards the transaction amount is performed. For example, considering the transaction amount is Rs.40000. The savings account comprises Rs.20000 and OD limit is Rs.30000. Then, the payment towards the transaction in terms of credit line can be performed by debiting Rs.10000 from savings and Rs.30000 from OD account. In other embodiment, Rs.20,000 from savings account and Rs.20,000 from OD account respectively debited towards payment of transaction amount in a single transaction.

The predefined interval for the installments is the time interval after expiry of which the instalment amount has to be paid. For example, the customer avails a credit limit of Rs.30,000 towards settling the transaction amount of Rs.30,000. The customer opts an installment tenure of 5 months, number of installments as 5, installment amount Rs.6000 at the interval of 1 month. That means, for 5 months the customer pays Rs.6000 each month. In addition, an interest amount is paid by the customer for availing the credit for completing the transaction. The interest amount is paid to the issuing bank. For example, in case the interest amount for credit based transaction is being recovered from the merchant, then the interest amount is debited from the funds by the merchant during transfer of transaction amount which is in turn paid out to the issuing bank. The interest rate is the rate which is levied on the customer for availing the credit limit and converting the credit limit into installments. In an embodiment, the processor 200, optionally, transmits the transaction request to the credit balance account server 104 for authorization.

The transaction storage unit 204, the merchant storage unit 206, the customer storage unit 208 and the tenure storage unit 210 include, but are not limited to, computer readable media having executable instructions. Such computer readable media can be any available media which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or network attached storage, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

The processor 200 transmits the received one or more tenure parameters along with the authentication information to the issuing bank and/or credit balance account server 104 associated to the savings account and the credit balance account. The credit balance account server 104 validates the authentication information received by the processor 200.

The transaction amount is debited from the credit balance account and is credited into the linked savings account of the customer. Then, the transaction amount from the customer's savings account is transferred to the acquiring account upon validating the authentication information by the credit balance account server 104 for facilitating credit based transactions.

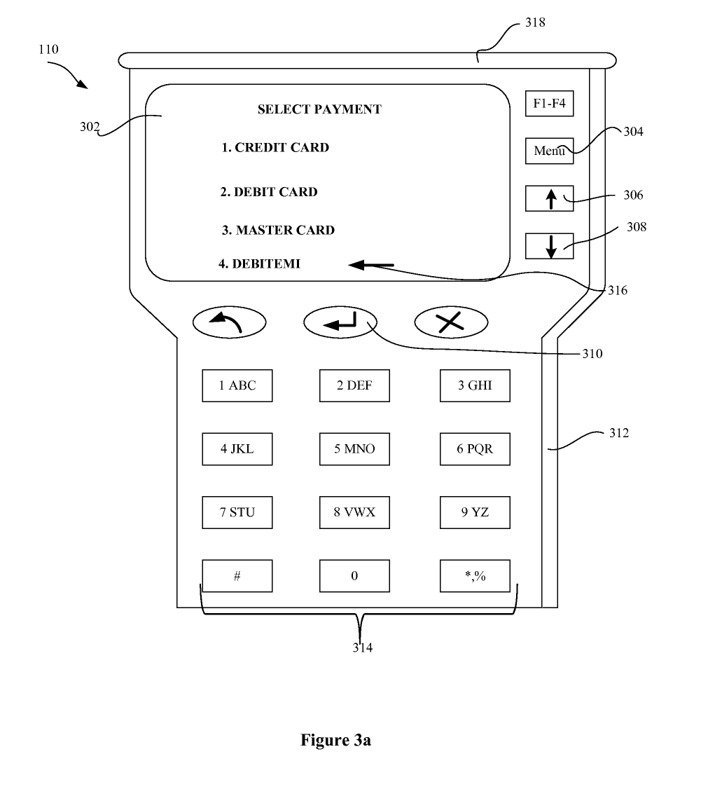

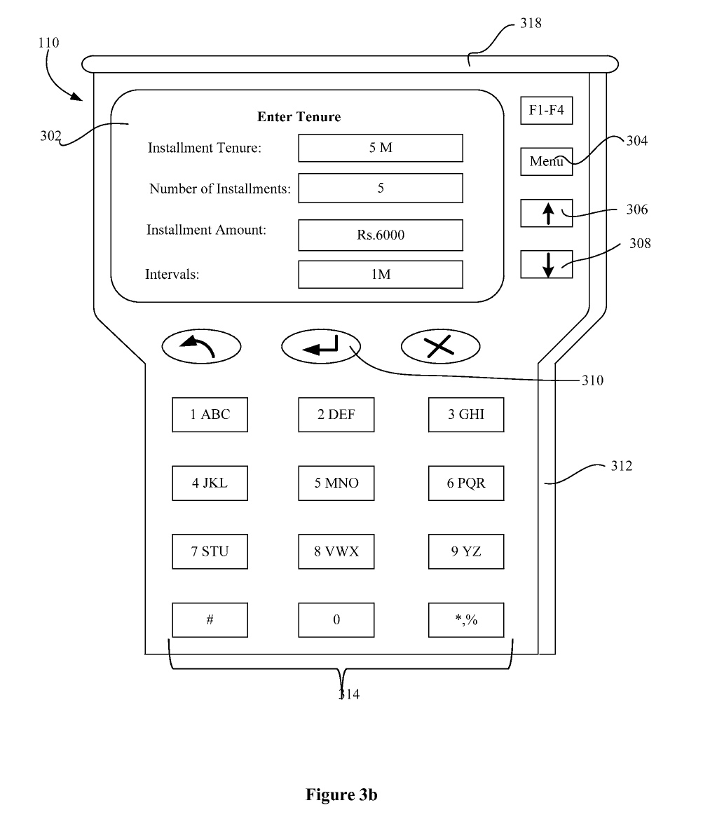

FIG. 3a illustrates an exemplary computing device 110 such as POS installed with credit based transaction application labelled as “DebitEMI” in accordance with an embodiment of the present disclosure. The POS 110 comprises the input unit including numeric and alphanumeric keys referred as 314, special character keys (enter depicted as “ [symbol] ” 310, cancel key “ [symbol] , back key “ [symbol] ”), special function keys (F1-F4), menu key 304, arrow keys such as upward arrow key 306 and downward arrow key 308. The POS 110 has a display unit to display the payment option, one or more tenure parameters and acknowledgment information. The POS 110 has a data card reader terminal 318 and a transaction slip printer terminal 312. On the data card reader terminal 318, the merchant swipes the debit card and the transaction slip printer terminal 312 prints the transaction details on a paper slip. Assuming the customer purchases a mobile phone of Rs.30000 which is a transaction amount and wants to settle the transaction amount using a debit card associated to the customer's savings account. On the POS 110, the user (customer or the merchant) selects the menu key 304. After pressing the menu key 304, various payment options are displayed on the display unit 302. The payment options gives the customer with payment modes like paying the transaction amount using the credit card, debit card or would like to opt the “DebitEMI” option. Considering the customer's savings account has over draft (OD) limit of Rs.40000 and would like to use the OD limit which is the credit limit which can be used by the customer for transactions. Then, the customer chooses the “DebitEMI” payment option. After choosing the “DebitEMI” option, the merchant swipes the debit card of the customer on the card reader terminal 318 and enters the transaction amount (Rs.30000) to be recovered from the customer. Upon swiping the debit card, the transaction request is initiated and is transmitted along with the submitted transaction amount to the processor 200 of the transaction server 102.

FIG. 3b shows the entry of the one or more tenure parameters by the user on the exemplary computing device 110 i.e. POS 110 according to an embodiment of the present disclosure. After the user opts the “DebitEMI” option, the authorization module 200a of the transaction server 102 authorizes the transaction request by checking whether the debit card associated to the customer's savings account has a credit limit and also whether the transaction amount is less than or equal to the credit limit. Upon authorizing the transaction request, the user is facilitated to enter the one or more tenure parameters which is depicted as “Enter Tenure” on the display unit 302. The one or more tenure parameters include, but are not limited to, installment tenure, number of installment, installment amount and the predefined interval. For example, the user enters the installment tenure as 5M which is for 5 months, number of installment as 5, installment amount as Rs.6000 and intervals as 1M, 1 month, by using the numeric keys 314.

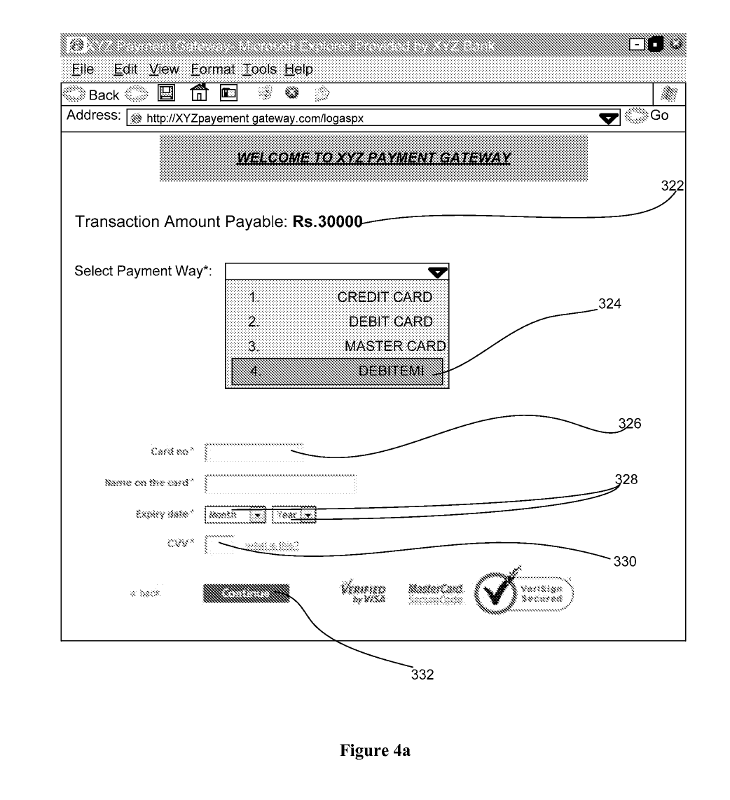

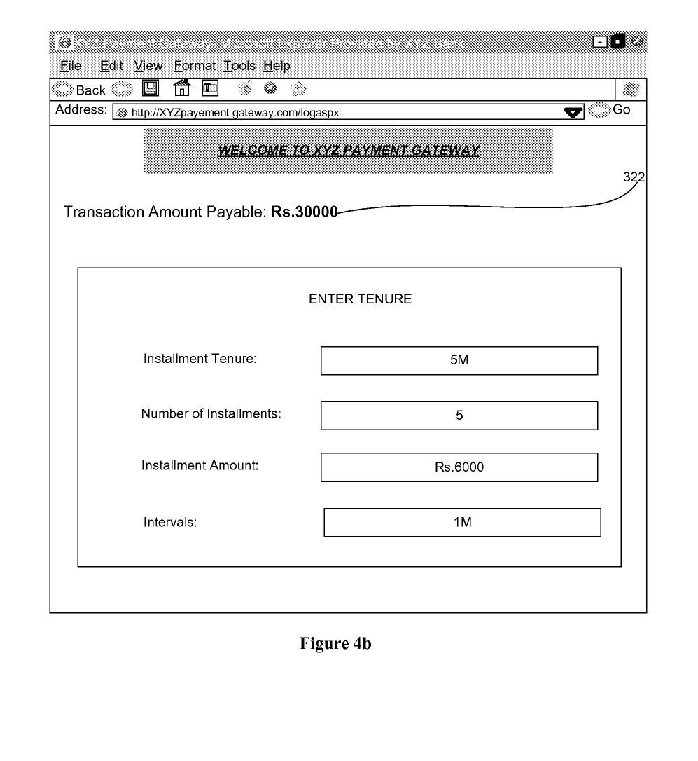

FIG. 4a illustrates another exemplary computing device 110 such as computer used by a user to avail credit based transaction in an online shopping portal through a web browser in accordance with an embodiment of the present disclosure. The customer accesses into the shopping portals/website named by “XYZ online shopping” by entering the website address using Internet. Assuming the customer purchases a mobile phone of Rs.30000 which is a transaction amount and would like to settle the transaction amount using a debit card associated to the customer's savings account. The shopping portal redirects the customer to the payment gateway for making the payment towards settling the transaction amount. The payment gateway of the “XYZ online shopping” displays the transaction amount payable 322 by the customer and provides payment options like making the transfer of the transaction amount using the credit card or debit card of the customer or would like to opt the “DebitEMI” option. Assuming the customer's savings account has over draft (OD) limit of Rs.40000 which the customer would like to use it towards purchasing the mobile phone by converting it into an installment plan. Then, the customer chooses the “DebitEMI” 324 payment option. After choosing the “DebitEMI” option 324, the customer enters various debit card details such as card number 326, name on the card, expiry information 328 and security verification code (CVV) 330. Upon submitting the debit card details, the transaction request is generated and thus the transaction request is processed by the processor 200 of the transaction server 102 based on the received debit card details submitted by the customer.

FIG. 4b shows the entry of the one or more tenure parameters by the user on the payment gateway of the “XYZ online shopping” according to an embodiment of the present disclosure. After the user opts the “DebitEMI” option, the authorization module 200a of the transaction server 102 authorizes the transaction request by checking whether the debit card used is linked to a credit balance account having a credit limit and also whether the transaction amount is less than or equal to the credit limit. Upon authorizing the transaction request, the user is facilitated to enter the one or more tenure parameter on the payment gateway depicted as “Enter Tenure”. The one or more tenure parameters include, but are not limited to, installment tenure, number of installment, installment amount and the predefined interval. For example, the user enters the installment tenure as 5M which is for 5 months, number of installment as 5, installment amount as Rs.6000 and intervals as 1M (1 month).

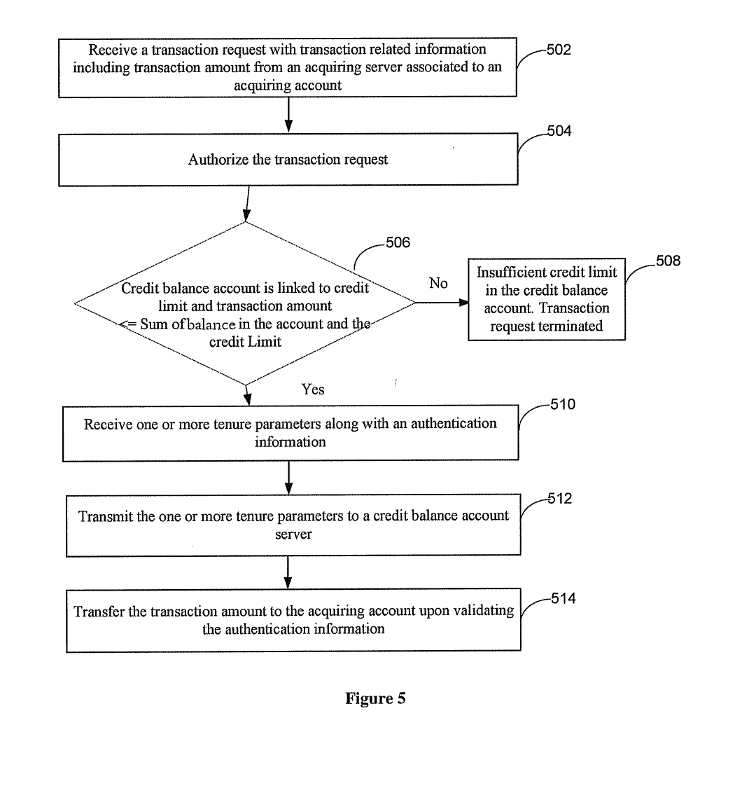

FIG. 5 illustrates an exemplary method for facilitating a credit based transactions over the network 108 in accordance with an embodiment of the present disclosure. At step 502, the processor 200 receives the transaction request from the acquiring server 106 associated to the acquiring account. The transaction request is linked to a credit balance account in the credit balance account server 104 and includes the transaction related information having transaction amount. The credit balance account is linked to savings account of the customer in the credit balance account server 104. The transaction request is originally initiated by the customer using the computing device 110 by opting the “DebitEMI” option. The customer can opt for the “DebitEMI” option only when the customer uses the debit card associated to the savings account of the customer which is further linked to the credit balance account. In an embodiment, the credit balance account is linked to a credit limit. For example, a customer at a retail store purchases a mobile phone of Rs.30000 which is the transaction amount, wherein the customer has a debit card associated to the savings account and an OD account having the credit limit of Rs.40000 which the customer wish to use at the time of purchase by opting “DebitEMI” option. At step 504, the authorization module 200a authorizes the transaction request. At step 506, the authorization module 200a checks whether the credit balance account is linked to the credit limit and the transaction amount is less than or equal to the credit limit. In case, the transaction amount is not less than or equal to the credit limit then the transaction request is terminated and is not processed as illustrated at step 508

In case, the transaction amount is less than or equal to the credit limit, then the transaction request is processed i.e. for example, the credit limit in the OD account is Rs.40000 which is more than the transaction amount Rs.30000, then the transaction server 102 facilitates the customer to avail the credit based transaction by using the credit limit from the OD account at the time of purchasing the mobile phone. The credit limit used by the customer at the time of purchase is converted into installments when the customer opts the “DebitEMI” option. Therefore, at step 510, the one or more tenure parameters along with an authentication information is received by the processor 200 from the acquiring server 106, when the transaction amount is less than or equal to the credit limit in the credit balance account. For example, the number of installments to be 3, predefined interval is 1 month and installment amount to be paid is Rs.10000. In an embodiment, the one or more tenure parameters are modifiable by the customer anytime during the installment tenure. At step 512, the processor 200 transmits the one or more tenure parameters to the credit balance account server 104 associated to the issuing bank. In an embodiment, the one or more tenure parameters are transmitted to the credit balance account server 104 associated to the issuing bank through the acquiring server 106 associated to the acquiring bank associated to the acquiring account. The authentication information includes information including but not limited to a personal identification number (PIN), password, biometric, signature, images, sound, music, numbers, alphanumerical numbers, word, phrase and a combination thereof. Lastly, at step 514, the processor 200 transfers the transaction amount i.e. Rs.30000 to the acquiring account upon validating the authentication information by the credit balance account server 104 for facilitating credit based transactions. For example, if the authentication information inputted by the user is a password then the inputted password is validated by the credit balance account server 104 for processing the transfer of the transaction amount. At the time of purchase, the transaction amount is debited from the credit balance account, for example, OD account and is credited into the savings account of the customer. Next, the credited transaction amount to the savings account of the customer is in turn debited and is transferred to the acquiring account of the acquiring bank relating to the merchant for settling the transaction amount. In an embodiment, the customer repays the credit limit used for the settling the transaction amount in predetermined installments as specified in the one or more tenure parameters either electronically and/or manually. For example, the installment amount along with the interest rate of amount can be in a form of cheque, cash and electronic cash which are used to credit back the credit limit used at the time of purchase for settling the transaction amount. Along with the credit limit, the customer pays the interest amount which is relied on the customer for availing the credit limit and converting the availed credit limit into instalments. The interest amount depends on the interest rate which is decided based on policies of the issuing bank 106. In an embodiment, the transaction server 102 debits an interest amount from the acquiring account for providing the application of using “DebitEMI” option which is in turn is repaid to the issuing bank.

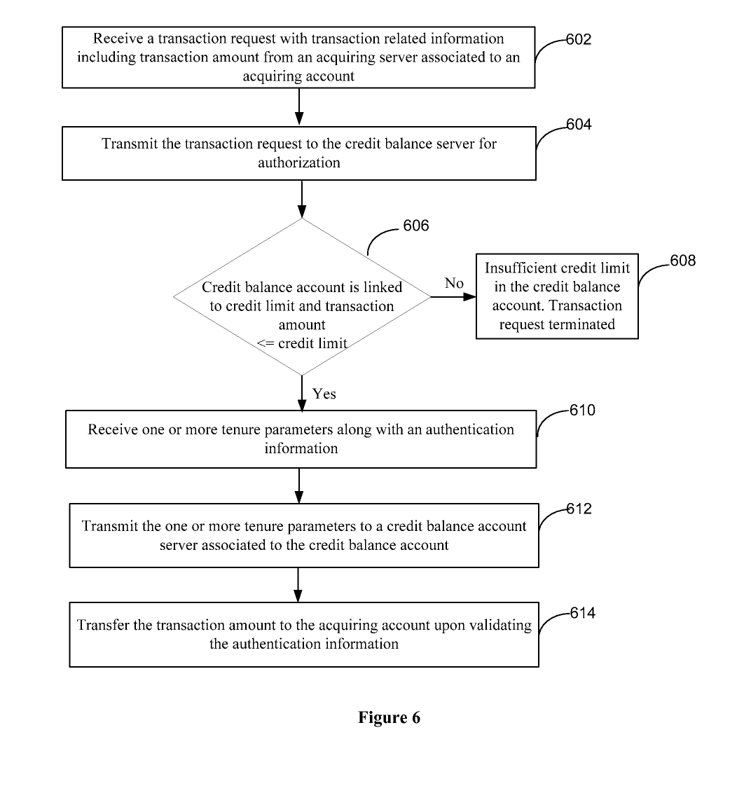

FIG. 6 illustrates an exemplary method for availing the credit based transaction in accordance with an alternative embodiment of the present disclosure. At step 602, the processor 200 receives the transaction request from the acquiring server 106 associated to the acquiring account. The transaction request includes the transaction related information having transaction amount. The transaction request is initiated by opting the “DebitEMI” option using the debit card associated to the savings account of the customer which is further linked to the credit balance account. For example, a customer at a retail store purchases a mobile phone of Rs.30000 which is the transaction amount, wherein the customer has a debit card linked to the savings account having the credit limit of Rs.40000. The purchaser wishes to use transact by opting “DebitEMI” which facilitates the credit based transaction at the time of purchase. At step 604, the processor 200 transmits the transaction request to the issuing bank and/or the credit balance server 104 to perform authorization. At step 606, the transaction request is authorized by the issuing bank and the credit balance server 104 associated to the server of issuing bank by checking whether the transaction amount is less than or equal to the balance in the account of the issuing bank and the credit limit in the. The issuing bank and/or the credit balance server 104 sends the information of whether the sum of balance in the account and the credit limit in the credit balance account is greater than or equal to the transaction amount, to the transaction server 102. In another embodiment, the issuing bank and/or the credit balance server 104 sends the information of whether the credit limit in the credit balance account is greater than or equal to the transaction amount, to the transaction server 102. Therefore, when the issuing bank and/or the credit balance server 104 sends the information such as the transaction amount is not less than or equal to the credit limit then the transaction request is terminated and is not processed by the transaction server 102 as illustrated at step 608. For example, if the transaction amount is Rs.45000 and the credit limit is

Rs.40000 then the transaction request of purchasing the mobile phone using the “DebitEMI” option is terminated.

In case, the transaction amount is less than or equal to the credit limit then the transaction request is processed i.e. for example, the credit limit Rs.40000 is more than the transaction amount Rs.30000, then the credit limit can be used by the customer at the time of purchasing the mobile phone and converting the repayment of the credit limit into installments. Then, at step 610, the one or more tenure parameters along with an authentication information is received by the processor 200 from the acquiring server 106, when the transaction amount is less than or equal to the credit limit in the credit balance account. For example, the number of installments to be 3, predefined interval is 1 month and installment amount to be paid is Rs.10000. In an embodiment, the one or more tenure parameters can be updated by the user (here customer) a predetermined number of times during the installment tenure. At the time of purchase, the credit limit is debited for settling the transaction amount. At step 612, the processor 200 then transmits the one or more tenure parameters to the issuing bank and/or the credit balance account server 104 associated to the credit balance account. In an embodiment, the one or more tenure parameters are transmitted to the credit balance account server 104 through the acquiring server 106 associated to the acquiring account. Lastly, at step 614, the processor 200 transfers the transaction amount i.e. Rs.30000 from the credit balance account to the acquiring account upon validating the authentication information by the credit balance account server 104 for facilitating credit based transactions. In an embodiment, the customer repays the credit limit used for the settling the transaction amount in predetermined installments as specified in the one or more tenure parameters either electronically and/or manually. For example, the installment amount along with the interest rate of amount can be in a form of cheque, cash and electronic cash which are used to credit back the credit limit used at the time of purchase for settling the transaction amount. The interest amount is charged on the customer for converting the credit limit into installments which depends on policies of the acquirer associated to the issuing bank 106. Then the amount is debited from the savings account and is credited to settle the transaction amount. In an embodiment, the transaction server 102 debits an interest amount from the acquiring account for providing the application of using “DebitEMI” which is in turn is repaid to the issuing bank.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

| Reference Numerals | Description |
|---|---|
| Transaction Server | 102 |
| Credit Balance Account Server | 104 |
| Acquiring Server | 106 |
| Network | 108 |
| Computing Device | 110 |
| Processor | 200 |
| Authorisation Module 200a | 200a |
| Storage Module | 202 |
| Transaction Storage Unit | 204 |
| Merchant Storage Unit | 206 |
| Customer Storage Unit | 208 |
| Tenure Parameters Storage Unit | 210 |

1. A method for facilitating credit based transactions, said method comprising steps of:
receiving, by a processor configured in a transaction server connected to a network, a transaction request from an acquiring server associated to an acquiring account, said transaction request, is linked to at least one of an account and a credit balance account and, comprises transaction related information including transaction amount, wherein the credit balance account is linked to credit limit;
authorizing, by an authorization module configured in the processor, the transaction request when the transaction amount is less than or equal to the at least one of:
sum of balance in the account and the credit limit in the credit balance account; and
the credit limit in the credit balance account;
receiving, by the processor from the acquiring server over the network, one or more tenure parameters along with an authentication information upon authorizing the transaction request;
transmitting, by the processor, the one or more tenure parameters along with the authentication information to an issuing server associated to the account and a credit balance account server associated to the credit balance account, wherein the issuing server and the credit balance account server connected to the network validates the authentication information received by the processor; and
transferring the transaction amount to the acquiring account upon validating the authentication information by the at least one of the issuing server and the credit balance account server for facilitating credit based transactions.

2. The method as claimed in claim 1, wherein the transaction request is optionally transmitted to the at least one of the issuing server and the credit balance account server for authorization.

3. The method as claimed in claim 1, wherein the transaction request is initiated by the user using a computing device selected from at least one of mobile phone, Interactive Voice Response (IVR) device, computer, Personal Digital Assistants (PDA), point of sale (POS), Electronic Data Capture (EDC) device, Automated Teller Machine (ATM), radio-related device and communication devices capable of applying for credit against the credit balance account.

4. The method as claimed in claim 1, wherein the one or more tenure parameters comprises installment tenure, number of installments, installment amount and predefined intervals of installment.

5. The method as claimed in claim 1, wherein the one or more tenure parameters is modifiable by the user during the installment tenure.

6. The method as claimed in claim 1, wherein the one or more tenure parameters is transmitted to the at least one of the issuing server and the credit balance account server through the acquiring server associated to the acquiring account.

7. The method as claimed in claim 1, wherein the authentication information is selected from a group comprising a personal identification number (PIN), password, biometric, signature, images, sound, music, numbers, alphanumerical numbers, word and phrase.

8. The method as claimed in claim 1, wherein the credit balance account is selected from a group comprising an overdraft (OD) account, a loan account, a mortgage account and installment loan account.

9. The method as claimed in claim 8, wherein the credit balance account is linked to the account selected from at least one of a savings account, a fixed deposit account and a checking account, and a money market account.

10. The method as claimed in claim 1, wherein the transaction request further comprises at least one of a debit card number, a transaction code, a transaction location, a transaction identification (ID), a transaction description, a transaction originator, a transaction date and a transaction time.

11. The method as claimed in claim 1, wherein the transaction request, the acquiring account, the account, the credit balance account, the one or more tenure parameters and the authentication information are stored in a storage module configured in the transaction server.

12. A system for facilitating credit based transactions, said system comprising:
an acquiring server configured to communicate over a network, said acquiring server is associated to an acquiring account;
an issuing server configured to communicate over the network, said issuing server is associated to an account;
a credit balance account server connected to the network, wherein the credit balance account is associated to a credit balance account linked to credit limit;
a computing device communicate over the network, said computing device comprises an input unit and a display unit;
a transaction server comprising a processor, said processor is configured to:
receive a transaction request from the acquiring server, said transaction request, is linked to at least one of the account and the credit balance account and, comprises transaction related information including transaction amount;
authorize, by an authorization module configured in the processor, the transaction request when the transaction amount is less than or equal to the at least one of:
sum of balance in the account and the credit limit in the credit balance account; and
the credit limit in the credit balance account;
receive, from the acquiring server, one or more tenure parameters along with an authentication information upon authorizing the transaction request;
transmit the one or more tenure parameters along with the authentication information to the issuing server associated to the account and the credit balance account server associated to the credit balance account, wherein the credit balance account server validates the authentication information received by the processor; and
transfer the transaction amount to the acquiring account upon validating the authentication information by the at least one of the issuing server and the credit balance account server for facilitating credit based transactions.

13. The system as claimed in claim 12 further comprises a storage module configured in the transaction server to store the transaction request, the acquiring account, the account, the credit balance account, the one or more tenure parameters and the authentication information.

14. The system as claimed in claim 12, wherein a user initiates the transaction request using the computing device selected from at least one of point of sale (POS), Electronic Data Capture (EDC), Interactive Voice Response (IVR), Automated Teller Machine (ATM), mobile device, computer, Personal Digital Assistants (PDA), radio-related device, contactless device and communication devices applying for credit against the credit balance account.

15. A method for facilitating credit based transactions, said method comprising steps of:
receiving, by a processor configured in a transaction server connected to a network, a transaction request from an acquiring server associated to an acquiring account, said transaction request comprises transaction related information including transaction amount, and is linked to at least one of an account and a credit balance account linked to credit limit;
transmitting, by the processor, the transaction request to at least one of an issuing server associated to the account and a credit balance account server associated to the credit balance account for authorization;
receiving, by the processor from the acquiring server, one or more tenure parameters along with an authentication information upon authorization of the transaction request;
transmitting, by the processor, the one or more tenure parameters along with the authentication information to the at least one of the issuing server and the credit balance account server, wherein the at least one of the issuing server and the credit balance account server connected to the network validates the authentication information received by the processor; and
transferring the transaction amount to the acquiring account upon validating the authentication information by the at least one of the issuing server and the credit balance account server for facilitating credit based transactions.

16. The method as claimed in claim 15, wherein the authorization comprises determining the transaction amount is less than or equal to at least one of:
sum of balance in the account and the credit limit in the credit balance account; and
the credit limit in the credit balance account.

17. A transaction server connected to a network comprising a processor is configured to:
receive a transaction request from an acquiring server associated to an acquiring account, said transaction request comprises a transaction related information including transaction amount, and is linked to at least one of an account and a credit balance account linked to credit limit;
authorize, by an authorization module configured in the processor, the transaction request when the transaction amount is less than or equal to at least one of:
sum of balance in the account and the credit limit in the credit balance account^{.} and
the credit limit in the credit balance account;
receive, from the acquiring server, one or more tenure parameters along with an authentication information upon authorizing the transaction request;
transmit the one or more tenure parameters along with the authentication information to at least one of an issuing server associated to the account and the credit balance account server, wherein the at least one of the issuing server and the credit balance account server connected to the network validates the authentication information received by the processor; and
transfer the transaction amount to the acquiring account upon validating the authentication information by the at least one of the issuing server and the credit balance account server for facilitating credit based transactions.

18. The transaction server as claimed in claim 17 further comprises a storage module configured in the transaction server to store the transaction request, the acquiring account, the account, the credit balance account, the one or more tenure parameters and the authentication information.
